(19) United States
(12) Patent Application Publication
(10) Pub. No.: US 2026/0180261 A1
(43) Pub. Date: Jun. 25, 2026

(54) Safety Device for Electrical Outlet

(71) Applicant: Ethan Whorton Page, Anniston, AL (US)

(72) Inventor: Ethan Whorton Page, Anniston, AL (US)

(21) Appl. No.: 18/990,524

(22) Filed: Dec. 20, 2024

(51) Int. Cl. H01R 13/713; G08B 7/06; H01R 13/66

(52) U.S. Cl. CPC H01R 13/713; G08B 7/06; H01R 13/6691

(57) ABSTRACT

A temperature actuated safety device for sensing increased temperatures in the vicinity of an electrical outlet and providing an alert of the condition is provided herein. Here, a safety device can be coupled to an outlet and can include an alarm support member; an alarm coupled to the alarm support member; a switch coupled to the alarm support member, the switch being electrically connected to a power source and to the alarm; and a shape memory alloy member that is immovably coupled to the alarm support member and is also coupled to the switch. The shape memory alloy is configured to actuate the switch to provide power to the alarm when the shape memory alloy reaches a transformation temperature that is indicative of a dangerous temperature condition in or around the electrical outlet.

### TECHNICAL FIELD

The present disclosure relates generally to the field of safety devices for use with electrical outlets. More specifically, the disclosure is directed to an apparatus comprising a temperature actuated safety device for use with an electrical outlet to prevent and warn of electrical fires.

### BACKGROUND ART

Electrical outlets are a significant source of house fires leading to injuries and property damage. According to the U.S. Consumer Product Safety Commission, electrical outlets are involved in over 5,000 fires every year. There are a variety of causes for fires emanating from an electrical outlet, including overloading the outlet, use of a damaged outlet, a loose connection within an outlet, or improper wiring of the outlet. Electrical outlet fires can also be caused by external sources such as damaged extension cords or appliances that are connected to the outlet. Any of these can cause overheating within the outlet that can ignite nearby combustible material.

As a result, there is a need for safety devices that can provide an alert of dangerously increasing temperatures within an electrical outlet that could potentially cause an electrical fire. Such alarm would allow individuals to attempt depower or remove the load on the outlet to prevent a fire from starting or to exit the structure before an electrical fire begins or becomes fully involved.

### SUMMARY OF THE INVENTION

This disclosure describes an apparatus comprising a temperature actuated safety device for use with an electrical outlet to prevent and warn of electrical fires. Advantageously, an embodiment may include: an alarm support member; an alarm coupled to the alarm support member; a switch coupled to the alarm support member, the switch being electrically connected to a power source and the switch being further electrically connected to the alarm; and a shape memory alloy member, the shape memory alloy member having two ends, where the first end is immovably coupled to the alarm support member and the second end is coupled to the switch; wherein the shape memory alloy is configured to actuate the switch to provide power to the alarm when the shape memory alloy reaches a transformation temperature. Advantageously, an embodiment may further include an electrical outlet.

In some embodiments, the alarm support member may be removably coupled to an electrical outlet. In some embodiments, the shape memory alloy may comprise nitinol. In some embodiments, the shape memory alloy may comprise a spring. In some embodiments, the alarm may emit an audible sound when activated. In some embodiments, the alarm may provide a visual indicator when activated. In some embodiments, the transformation temperature is below the temperature at which electrical wiring or wire insulators may typically combust. In some embodiments, the transformation temperature is below the temperature at which the plastic components in or around an electrical outlet may combust. In some embodiments, the transformation temperature is between 30° C. and 70° C. In some embodiments, the transformation temperature is between 45° C. and 60° C.

The above summary presents a simplified overview to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE FIGURES

FIG. 1 is a front perspective of an electrical outlet having a base attached to the side of the electrical outlet that can be used to couple the described safety device to the outlet in accordance with an embodiment.

FIG. 2 is a front perspective of an electrical outlet having the described safety device coupled to the side of the electrical outlet using the base in accordance with an embodiment.

FIG. 3 is an internal view of the described safety device according to an embodiment.

FIG. 4 is an exploded view of the components of the described safety device according to an embodiment.

FIG. 5 is a depiction of the switch and shape memory alloy member when the switch is in a not actuated state according to an embodiment.

FIG. 6 is a depiction of the switch and shape memory alloy member when the switch is in an actuated state according to an embodiment.

### DETAILED DESCRIPTION

Unless otherwise defined, all terms (including technical and scientific terms) in this disclosure have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly defined otherwise in this disclosure. Well known functions or constructions may not be described in detail for brevity or clarity.

The terms “about” and “approximately” shall generally mean an acceptable degree of error or variation for the quantity measured in light of the nature or precision of the measurements. Numerical quantities given in this description are approximate unless stated otherwise, meaning that the term “about” or “approximately” can be inferred when not expressly stated.

The terminology used throughout the disclosure is for the purpose of describing particular embodiments only and is not intended to be limiting. The singular forms “a”, “an,” and “the” are intended to include the plural forms as well, unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure.

Reference will now be made in detail to embodiments of the present disclosure, one or more drawings of which are set forth herein. Each drawing is provided by way of explanation of the present disclosure and is not a limitation. It will be apparent to those skilled in the art that various modifications and variations can be made to the teachings of the present disclosure without departing from the scope of the disclosure.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

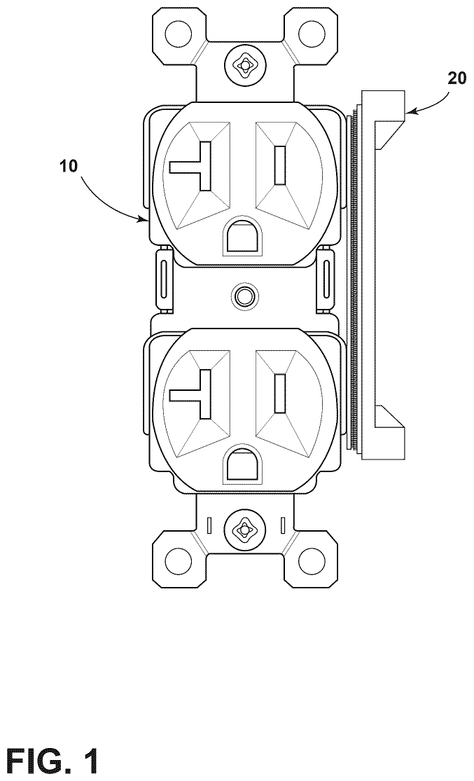

FIG. 1 depicts a duplex electrical outlet 10. In an embodiment, the disclosed invention may be used with a standard duplex electrical outlet operating at 120 volts and rated for 15 amps. In other embodiments, the disclosed invention may be used with any common electrical outlet, including, without limitation, 125 volt outlets, 240 volt outlets, 20 amp outlets, ground-fault circuit interrupter (GFCI) outlets, arc-fault circuit interrupter (AFCI) outlets, tamper resistant outlets, smart outlets, or any other outlet typically used in providing electrical service in residential, commercial, or industrial structures. FIG. 1 further depicts a base 20 that can be used to couple the presently disclosed safety device to an electrical outlet. It will be apparent to one of ordinary skill in the art that base 20 can be shaped so as to provide access to the side of electrical outlet 10 if necessary for accessing terminal screws or any other form of wiring connection point. It will be further apparent to one of ordinary skill in the art that base 20 may be affixed to electrical outlet 10 by appropriate means, including, without limitation, an appropriate adhesive or permanent mechanical connection or, in the alternative, base 20 may be removably coupled to the electrical outlet 10 using appropriate means, including, without limitation, a hook-and-loop material, mechanical fastening, or magnetic fastening.

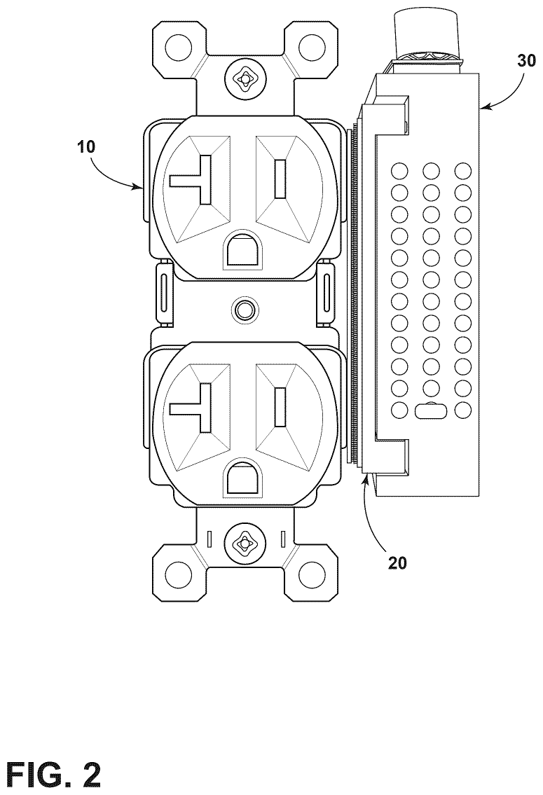

FIG. 2 depicts the presently disclosed safety device 30 coupled to a duplex electrical outlet 10. In this embodiment, the safety device 30 includes two channels that engage with the base 20 to removably couple the safety device 30 to the duplex electrical outlet 10. It will be apparent to those of skill in the art that other physical arrangements between base 20 and safety device 30 can be used to create a removable coupling between the base 20 and the safety device 30. In other embodiments, the safety device 30 may be directly attached to the duplex electrical outlet 10 without use of the base 20. In one embodiment, the housing of electrical outlet 10 can be designed to include protrusions that can engage with the channels of safety device 30. In other embodiments, the housing of electrical outlet 10 and safety device 30 may include respective male and female engagement points to directly couple safety device 30 to electrical outlet 10. In other embodiments, safety device 30 and electrical outlet 10 may be directly coupled using a hook-and-loop material, mechanical fastening, or magnetic fastening.

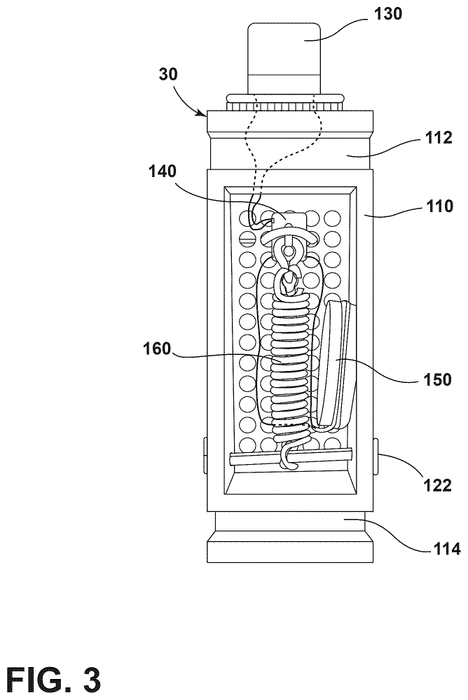

FIG. 3 depicts an internal view of the safety device. An alarm support member 110 serves as the body of the presently disclosed safety device. In this embodiment, the alarm support member 110 comprises a left wall, a right wall, a bottom wall, a top wall, and a back wall that define a space to house components of the presently disclosed invention. In the disclosed embodiment, channels 112 and 114 can engage with the base 20 to removably couple the safety device to the electrical outlet. In this embodiment, pin 122 extends across the alarm support member 110.

In this embodiment, an alarm 130 is disposed on the exterior of the alarm support member 110. In other embodiments, one or more of the left wall, right wall, or back wall of the alarm support member 110 may be extended to define a space to house the alarm 130. In this embodiment, alarm 130 provides an audible indicator when alarm 130 is triggered. In other embodiments, alarm 130 may alternatively or additionally provide a visual indicator when triggered.

In this embodiment, switch 140 is coupled to the alarm support member 110. In this embodiment, switch 140 is coupled to the alarm support member 110 using an appropriate adhesive applied between switch 140 and alarm support member 110. It will be apparent to one of ordinary skill in the art that switch 140 may be coupled to alarm support member 110 through other appropriate means, including, without limitation, a clamp mechanism, a bracket mechanism, a snap mechanism, or a magnetic mechanism that maintains switch 140 in a stable position relative to alarm support member 110 when an actuating force is applied to switch 140. Switch 140 is electrically connected to alarm 130. Switch 140 is further electrically connected to a power source 150. In this embodiment, power source 150 is a CR1225 battery. In other embodiments, power source 150 can be any source that can provide sufficient power to operate alarm 130. Switch 130 is coupled to a first end of shape memory alloy member 160. In this embodiment, shape memory alloy member 160 has a second end that is immovably coupled to the alarm support member 110 by passing pin 122 through an opening in the second end of shape memory alloy member 160. It will be apparent to one of ordinary skill in the art that the second end of shape memory alloy member 160 may be immovably coupled to the alarm support member 110 using other physical arrangements. As a non-limiting example, a post member could be extended from the back wall of alarm support member 110 to engage with the second end of shape memory alloy member 160 to immovably couple the shape memory alloy member 160 to the alarm support member 110. As another non-limiting example, the second end of shape memory alloy member 160 could be directly coupled to the bottom wall of the alarm support member 110.

In this embodiment, shape memory alloy member 160 comprises nitinol. Nitinol is a metal alloy of nickel and titanium. One of ordinary skill in the art will be aware that nitinol exhibits a shape memory effect. Shape memory alloys, such as nitinol, can be deformed at one temperature and then maintain that deformed shape. Once the alloy is heated above a transformation temperature, the alloy will recover its original, undeformed shape. The shape memory effect exhibited by nitinol occurs when the alloy undergoes a reversible phase transformation between the Austenite and Martensite phases. Nitinol enters the Martensite phase during low temperatures. In this phase, the alloy bends easily and can easily deform into a new shape. The alloy will retain that deformed shape after the deforming force is removed. Under high temperatures, the metal enters the Austenite phase. In this phase, it achieves maximum stiffness and is spring-like when bent. Thus, when the alloy is heated through its transformation temperature, it reverts to its Austenite phase and recovers its previous shape.

In this embodiment, shape memory alloy member 160 is sized such that in its deformed state it can be immovably connected to the alarm support member 110 at its second end while its first end can engage with switch 140 without exerting force sufficient to actuate switch 140. When shape memory alloy member 160 is heated through its transformation temperature, shape memory alloy member 160 contracts to its undeformed state. The force exerted when shape memory alloy member 160 contracts to its undeformed state is sufficient to actuate switch 140. In this embodiment, shape memory alloy member 160 comprises a spring shape. In other embodiments, shape memory alloy member 160 may comprise other shapes. As non-limiting examples, shape memory alloy member 160 may comprise a wire shape or a loop shape.

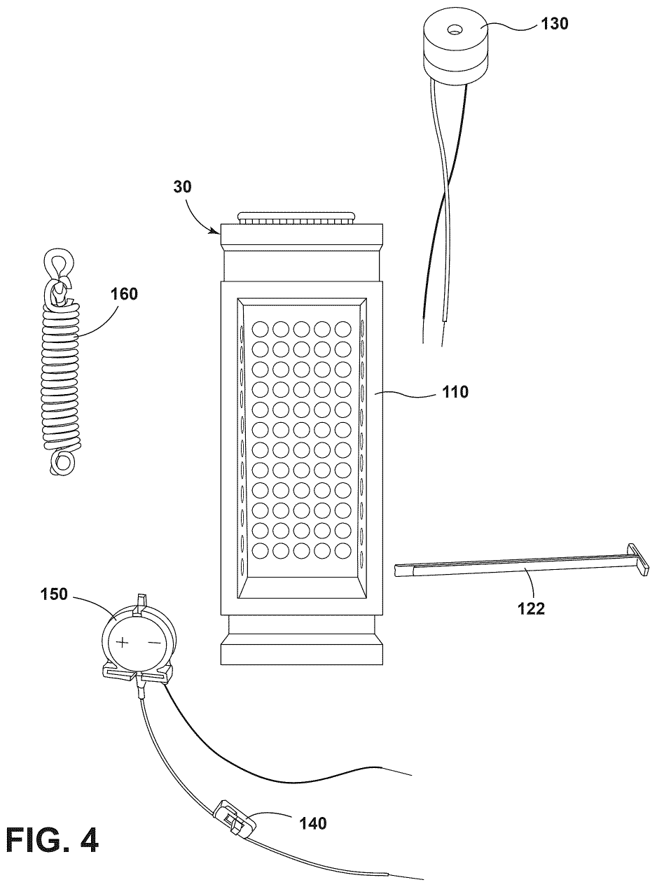

FIG. 4 depicts an exploded view of certain components of the safety device 30. Alarm support member 110 is shown with the components that would be located in or on alarm support member 110 in an embodiment removed. Shown in FIG. 4 are: 1) pin 122, 2) alarm 130 with wiring used to electrically connected alarm 130 with switch 140 and power source 150, 3) switch 140 with the wiring that electrically connects switch 140 to power source 150 and alarm 130, 4) power source 150 with the wiring that electrically connects power source 150 to switch 140 and alarm 130, and shape memory alloy member 160 in isolation.

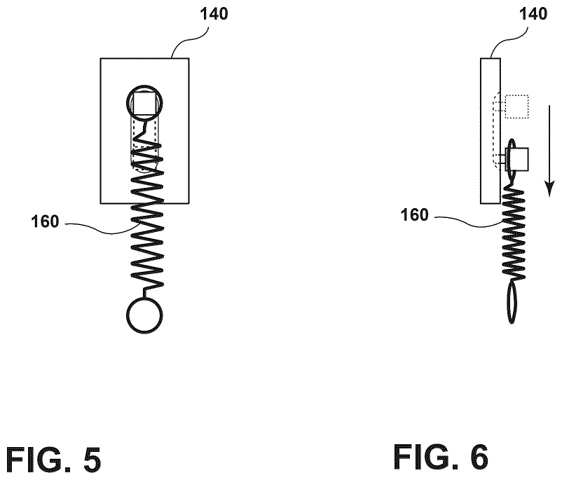

FIGS. 5 and 6 depict the operation of the shape memory alloy member 160 as it is heated through its transformation temperature. In FIGS. 5 and 6, the first end of shape memory alloy member 160 is coupled to switch 140. Although not shown, it is be understood that the second end of shape memory alloy member 160 is immovably coupled to the alarm support member 110 as described herein. In FIG. 5, shape memory alloy member 160 is in its deformed, extended state. In FIG. 6, shape memory alloy member 160 has reached its transformation temperature and, resultingly, contracted to its undeformed state. The force resulting from the contraction of shape memory alloy member 160 actuates spring 140.

Advantageously, the transformation temperature of the shape memory alloy member may be chosen such that the shape memory alloy member will maintain its deformed state at a normal operating temperature for an electrical outlet and return to its undeformed state when exposed to temperatures indicative of fire risk in an electrical outlet. In normal operation, an electrical outlet will maintain a temperature at or around ambient temperature. Typical electrical wiring using standard plastic insulation is known to start to burn or degrade significantly at around 90° C. (194° F.). The transformation temperature of the shape memory alloy member can be chosen to fall within a range defined by the normal operating temperature of an electrical outlet and temperatures at or around the degradation temperature of the electrical wiring and its insulation or other temperature indicative of the risk of an electrical outlet fire. One of ordinary skill in the art will be aware that the transformation temperature of nitinol can be controlled by adjusting the metallurgy of the alloy, including by adjusting the relative composition of nickel and titanium or by adding additional elements to the alloy, or by adjusting the processing technique used in creating the alloy. In one embodiment, the transformation temperature of the shape memory alloy member is chosen to be below 100° C. In another embodiment, the transformation temperature of the shape memory alloy member is chosen to be below 90° C. In another embodiment, the transformation temperature of the shape memory alloy member is chosen to be between 30° C. and 70° C. In another embodiment, the transformation temperature of the shape memory alloy member is chosen to be between 45° C. and 60° C.

An exemplary operation of the described safety device will now be provided. In operation, the safety device can be disposed alongside of an electrical outlet. At normal operating temperatures, the shape memory alloy member of the safety device will maintain a deformed shape in which it does not exert sufficient force to actuate the switch of the safety device. In operation, the temperature of and around the electrical outlet may increase as a result of, for example, overloading the outlet, use of a damaged outlet, a loose connection within the outlet, improper wiring of the outlet, or connection to damaged external sources. The transformation temperature of the shape memory alloy member will be chosen to be a temperature indicative of a risk of impending fire from the electrical outlet. When the temperature in or around the electrical outlet exceeds the transformation temperature of the shape memory alloy member, the shape memory alloy member will revert to its undeformed state. The reversion of the shape memory alloy member to its undeformed state will exert sufficient force on the switch to actuate the switch. Actuation of the switch will then provide power to the alarm of the safety device, causing the alarm to emit an indicator of the dangerous condition.

Herein, two elements may be described as being coupled. It should understood that such elements may be directly coupled to one another or, alternatively, indirectly coupled through intervening components, the use of which will be apparent to one of ordinary skill in the art.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the apparatus and/or methods disclosed and claimed herein may be made and/or executed without undue experimentation in light of the present disclosure. While the apparatus and methods of this invention have been described in terms of the embodiments included herein, it will be apparent to those of ordinary skill in the art that variations may be applied to the appartus and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

I claim:

1. An apparatus comprising:
an electrical outlet;
an alarm support member coupled to the electrical outlet;
an alarm coupled to the alarm support member;
a switch coupled to the alarm support member, the switch being electrically connected to a power source and the switch being further electrically connected to the alarm; and
a shape memory alloy member, the shape memory alloy member having two ends, where the first end is immovably coupled to the alarm support member and the second end is coupled to the switch;
wherein the shape memory alloy is configured to actuate the switch to provide power to the alarm when the shape memory alloy reaches a transformation temperature.

2. The apparatus of claim 1, wherein the alarm support member is removably coupled to the electrical outlet.

3. The apparatus of claim 1, wherein the shape memory alloy member comprises nitinol.

4. The apparatus of claim 1, wherein the shape memory alloy member comprises a spring.

5. The apparatus of claim 1, wherein the alarm emits an audible indication when activated.

6. The apparatus of claim 1, wherein the alarm emits a visual indication when activated.

7. The apparatus of claim 1, wherein the transformation temperature of the shape memory alloy member is at or below 100° C.

8. The apparatus of claim 1, wherein the transformation temperature of the shape memory alloy member is at or below 90° C.

9. The apparatus of claim 1, wherein the transformation temperature of the shape memory alloy member is between 30° C. and 70° C.

10. The apparatus of claim 1, wherein the transformation temperature of the shape memory alloy member is between 45° C. and 60° C.

11. A heat-actuated alarm for use with an electrical outlet comprising:
an alarm support member;
an alarm coupled to the alarm support member;
a switch coupled to the alarm support member, the switch being electrically connected to a power source and the switch being further electrically connected to the alarm; and
a shape memory alloy member, the shape memory alloy member having two ends, where the first end is immovably coupled to the alarm support member and the second end is coupled to the switch;
wherein the shape memory alloy is configured to actuate the switch to provide power to the alarm when the shape memory alloy reaches a transformation temperature.

12. The apparatus of claim 11, wherein the alarm support member is configured to be removably coupled to an electrical outlet.

13. The apparatus of claim 11, wherein the shape memory alloy member comprises nitinol.

14. The apparatus of claim 11, wherein the shape memory alloy member comprises a spring.

15. The apparatus of claim 11, wherein the alarm emits an audible indication when activated.

16. The apparatus of claim 11, wherein the alarm emits a visual indication when activated.

17. The apparatus of claim 11, wherein the transformation temperature of the shape memory alloy member is at or below 100° C.

18. The apparatus of claim 11, wherein the transformation temperature of the shape memory alloy member is at or below 90° C.

19. The apparatus of claim 11, wherein the transformation temperature of the shape memory alloy member is between 30° C. and 70° C.

20. The apparatus of claim 11, wherein the transformation temperature of the shape memory alloy member is between 45° C. and 60° C.
